(19) United States
(12) Patent Application Publication
(10) Pub. No.: US 2007/0116732 A1
(43) Pub. Date: May 24, 2007

(54) METHODS FOR MAKING TREATED AND/OR COATED CELLULOSE-CONTAINING SUBSTRATES

(75) Inventors: Sandra Lynn Goebel, Bloomington, MN (US); Donaldson J. Emch, Goodrich, MI (US); M. Lisa Perrine, Allison Park, PA (US)

Correspondence Address: PPG INDUSTRIES INC;INTELLECTUAL PROPERTY DEPT, ONE PPG PLACE, PITTSBURGH, PA, 15272, US

(73) Assignee: PPG INDUSTRIES OHIO, INC., Cleveland, OH (US)

(21) Appl. No.: 11/562,060

(22) Filed: Nov. 21, 2006

Related U.S. Application Data
(60) Provisional application No. 60/739,589, filed on Nov. 23, 2005.

(51) Int. Cl. A01N 25/00

(52) U.S. Cl. 424/405

(57) ABSTRACT

Disclosed are methods for making treated and/or coated cellulose-containing substrates and methods for reducing the cycle time to make a treated and/or coated cellulose-containing substrate.

### CROSS-REFERENCE TO RELATED APPLICATIONS

This application claims the benefit of U.S. Provisional Patent Application Ser. No. 60/739,589, filed Nov. 23, 2005.

### FIELD OF THE INVENTION

The present invention relates to methods for making treated and/or coated cellulose-containing substrates and methods for reducing the cycle time to make a treated and/or coated cellulose-containing substrate.

### BACKGROUND INFORMATION

Articles made from cellulose-containing materials, such as window frames, furniture, cabinets, flooring, and the like, are often treated and/or coated with one or more compositions to enhance the appearance of the article, and/or provide protection from various environmental conditions that can deteriorate the underlying article. The formulation of these compositions can vary widely. However, regardless of formulation, many manufacturers of such articles desire to reduce the amount of time required to dry and cure the applied compositions so as to, for example, reduce production time and/or increase floor space that is available in a manufacturing plant.

As a result, there is a desire for new methods of making treated and/or coated cellulose-containing substrates and/or methods for reducing the cycle time to dry compositions deposited on a cellulose-containing substrate.

### SUMMARY OF THE INVENTION

In certain respects, the present invention is directed to methods for making an at least partially treated and/or coated cellulose-containing substrate. These methods comprise: (a) applying a treatment composition or a coating composition to at least a portion of the cellulose-containing substrate; and (b) drying the treatment composition or coating composition. In these methods, the drying step comprises (i) exposing the cellulose-containing substrate simultaneously to warm air and infrared radiation at conditions sufficient to form a pre-dried treatment or coating on and/or within at least a portion of the cellulose-containing substrate; and (ii) exposing the cellulose-containing substrate comprising the pre-dried treatment or coating simultaneously to warm air and infrared radiation at conditions sufficient to form a dried treatment or coating on and/or within at least a portion of the cellulose-containing substrate.

In other respects, the present invention is directed to methods for reducing the cycle time for drying a treatment composition or coating composition deposited on at least a portion of a cellulose-containing substrate. These methods comprise drying the treatment composition or coating composition by a method comprising (i) exposing the cellulose-containing substrate simultaneously to warm air and infrared radiation at conditions sufficient to form a pre-dried treatment composition or coating composition on and/or within at least a portion of the cellulose-containing substrate; and (ii) exposing the cellulose-containing substrate comprising the pre-dried treatment composition or coating composition simultaneously to warm air and infrared radiation at conditions sufficient to form a dried treatment composition or coating composition on and/or within at least a portion of the cellulose-containing substrate.

In yet another respect, the present invention is directed to methods for making a cellulose-containing substrate at least partially coated with a multi-component composite coating. These methods comprise: (a) applying a wood pretreatment composition to at least a portion of the cellulose-containing substrate, (b) drying the wood pretreatment composition, (c) applying an intermediate coating composition to the cellulose-containing substrate over at least a portion of the wood pretreatment composition, (d) drying the intermediate coating composition, (e) applying a topcoat coating composition to the cellulose-containing substrate over at least a portion of the intermediate coating composition, and (f) drying the topcoat coating composition. In these methods of the present invention, (1) the wood pretreatment composition is dried by (i) exposing the cellulose-containing substrate simultaneously to warm air and infrared radiation at conditions sufficient to form a pre-dried treatment on and/or within at least a portion of the cellulose-containing substrate; and (ii) exposing the cellulose-containing substrate comprising the pre-dried treatment simultaneously to warm air and infrared radiation at conditions sufficient to form a dried treatment on and/or within at least a portion of the cellulose-containing substrate; (2) the intermediate coating composition is dried by (i) exposing the cellulose-containing substrate simultaneously to warm air and infrared radiation at conditions sufficient to form a pre-dried intermediate coating composition on and/or within at least a portion of the cellulose-containing substrate; and (ii) exposing the cellulose-containing substrate comprising the pre-dried intermediate coating composition simultaneously to warm air and infrared radiation at conditions sufficient to form a dried intermediate coating composition on and/or within at least a portion of the cellulose-containing substrate; and/or (3) the topcoat coating composition is dried by (i) exposing the cellulose-containing substrate simultaneously to warm air and infrared radiation at conditions sufficient to form a pre-dried topcoat coating composition on and/or within at least a portion of the cellulose-containing substrate; and (ii) exposing the cellulose-containing substrate comprising the pre-dried topcoat coating composition simultaneously to warm air and infrared radiation at conditions sufficient to form a dried topcoat coating composition on and/or within at least a portion of the cellulose-containing substrate.

In yet other respects, the present invention is directed to methods for reducing the amount of cure catalyst and/or curing agent required in a single component or extended potlife multi-component coating composition to be dried within a selected amount of time after application to at least a portion of a cellulose-containing substrate. These methods comprise drying the coating composition by (i) exposing the cellulose-containing substrate simultaneously to warm air and infrared radiation at conditions sufficient to form a pre-dried coating composition on and/or within at least a portion of the cellulose-containing substrate; and (ii) exposing the cellulose-containing substrate comprising the pre-dried coating composition simultaneously to warm air and infrared radiation at conditions sufficient to form a dried coating on and/or within at least a portion of the cellulose-containing substrate.

The present invention is also directed to cellulose-containing substrates at least partially coated by such methods as well as apparatus for coating a cellulose-containing substrate by such methods.

### DETAILED DESCRIPTION OF EMBODIMENTS OF THE INVENTION

For purposes of the following detailed description, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this application, the use of the singular includes the plural and plural encompasses singular, unless specifically stated otherwise. In addition, in this application, the use of “or” means “and/or” unless specifically stated otherwise, even though “and/or” may be explicitly used in certain instances.

As previously indicated, certain embodiments of the present invention are directed to methods for making an at least partially treated and/or coated cellulose-containing substrate. As used herein, the term “cellulose-containing substrate” is meant to include substrates that comprise cellulose, which is a complex carbohydrate, (C₆II₁₀O₅)ₙ, that is composed of glucose units. Specific non-limiting examples of cellulose-containing materials, suitable for use in the present invention, include hardwood, softwood, plywood, wood veneer, particleboard, chipboard, oriented strand board, and fiberboard. Such materials may be made entirely of wood, such as pine, oak, maple, mahogany, cherry, and the like. In some cases, however, the materials may comprise wood in combination with another material, such as a resinous material. Additional specific non-limiting examples of cellulose-containing substrates that may be coated in accordance with the present invention include wood/resin composites, such as phenolic composites, combinations of reclaimed wood and plastic, such as that sold under the tradename Trex®, from Trex Company, Inc, Fibrex®, which is a composite of wood fibers and thermoplastic polymers commercially available from Andersen Corporation, Bayport, Minn., and Latitudes® from Universal Forest Products, which is a wood composite product reinforced with cement, fibers, or plastic cladding and the like.

Certain embodiments of the methods of the present invention comprise the step of applying a composition to at least a portion of the cellulose-containing substrate. Suitable compositions that may be applied in accordance with the present invention include, for example, wood pretreatment compositions, colorizing compositions (such as wood stains and/or toners), intermediate coating compositions (sometimes known as primer, filler, and/or sealer compositions), as well as topcoat coating compositions, such as color coats and clear coats. Such compositions can be applied to the cellulose-containing substrate by any method known in the art, such as dipping, vacuum coating, flow coating, roll coating, brushing, and spraying.

Suitable wood pretreatment compositions that may be applied to a cellulose-containing substrate in accordance with the present invention include wood preservative treatment compositions, such as water-repellent treatment compositions. Such compositions need not always form a continuous film on the cellulose-containing substrate. Suitable wood pretreatment compositions include, for example, liquid compositions that comprise a mixture of a diluent, such as water and/or organic solvents, a film-forming resin, a wood preservative, a water repellent, and/or an organic ionizable compound, among other materials. Suitable wood preservative treatment compositions may be solvent-borne (at least 50 percent by weight, organic solvents) or waterborne (at least 50 percent by weight water).

Suitable organic solvents for use in a wood pretreatment composition applied in accordance with certain embodiments of the present invention include, for example, acetone, ketones, glycol ethers, aliphatic hydrocarbons, aromatic hydrocarbons and halogenated hydrocarbons, such as mineral spirits, n-hexane, cyclohexane, toluene, xylene, chlorobenzene and perchloroethylene. In certain embodiments, the pretreatment composition comprises from 50 to 98 percent by weight, such as 70 to 95 percent by weight of the diluent, based on the total weight of the composition.

Suitable water repellents for use in a wood pretreatment composition applied in accordance with certain embodiments of the present invention include, for example, paraffin wax, polybutene resins, silicone fluids, such as that available from Dow Corning Corporation under the tradenames DC 200® and DC1107 and Union Carbide Corporation under the tradename R270, silicone waxes, such as that available from Union Carbide Corporation under the tradename L-49, and poly-oxo-aluminum stearate available as MANALOX 403/60 from Manchem Corporation. In certain embodiments, the water repellent comprises an alpha olefin having 20 to 24 carbon atoms, an alpha olefin blend, a paraffin blend, or a mixture thereof, such as is described in U.S. Pat. Nos. 4,360,385 at col. 2, lines 36 to 68 and U.S. Pat. No. 4,404,239 at col. 2, line 39 to col. 3, line 3, the cited portions of both of which being incorporated by reference herein.

In certain embodiments, the water repellent is present in the wood pretreatment composition in an amount from 0.50 to 50 percent by weight, such as 0.50 to 20 percent by weight, or, in some cases, from 0.50 to 5.0 percent by weight, based on the total weight of the pretreatment composition.

Suitable wood preservatives for use in a wood pretreatment composition applied in accordance with certain embodiments of the present invention include, for example, biocides, fungicides, pesticides and/or algicides. Examples of such materials include organic tin compounds, such as triphenyl and tributyl tin oxide; chlorinated compounds, such as tri-, tetra-, and pentachlorophenol, mono- and dichloro naphthalenes; organic mercury compounds, such as phenyl mercury acetate and oleate, 3-iodo-2-propynyl butyl carbonate, Busan® 1025 available from Buckman Laboratories, Inc. (a blend of 10 percent, by weight of methylene bis(thiocyanate) and 10 percent by weight 2-(thiocyanomethylthio) benzothiazole in 80 percent by weight solvent); and metal naphthenates, such as zinc and copper naphthenates, as well as propiconazole, tebuconazole, imidicloprid, and zinc borate. In certain embodiments, the wood preservative is present in the wood treatment composition at a level of from 0.2 to 7.5, such as 0.5 to 3.0, percent by weight, based on the total weight of the composition. In certain embodiments, the wood preservative is present in the wood treatment composition at a level equal to or exceeding the “threshold concentration” of the wood preservative as determined by the T.M. 1-1994 soil block test published by the Window & Door Manufacturers Association.

Suitable film-forming resins for use in a wood pretreatment composition applied in accordance with certain embodiments of the present invention include alkyd resins (including urethane alkyd resins), acrylic resins, vinyl resins, epoxy resins, silicone resins, ethylenically unsaturated materials, polyester resins and polyurethane resins, as well as mixtures thereof. Suitable alkyd resins, for example, are disclosed in U.S. Pat. No. 4,404,239 at col. 4, lines 15 to 45, the cited portion of which being incorporated by reference herein. In certain embodiments, the film-forming resin is present in the wood pretreatment composition at a level of from 1 to 50, such as 1 to 10, percent by weight, based on the total weight of the composition.

Suitable organic ionizable compounds include those materials described in U.S. Pat. No. 4,404,239 at col. 4, line 46 to col. 6, line 11, the cited portion of which being incorporated by reference herein. In certain embodiments, the organic ionizable compound is present in the wood treatment composition at a level of from 0.1 to 5 percent by weight, such as 0.1 to 2 percent by weight, based on the total weight of the treatment composition.

Other conventional additives can be included in the wood pretreatment composition, such as surfactants, pigments, etc. In many cases, such additives comprise less than 5 percent by weight of the composition.

Suitable wood pretreatment compositions are disclosed, for example, in U.S. Pat. Nos. 4,360,365, 4,404,239, 4,913,972, and 5,228,905, each of which being incorporated herein by reference. Suitable wood pretreatment compositions are also commercially available and include, without limitation, those available under the tradenames PILT 70P Conductive Plus, PILT 71P Nonconductive Plus, PILT 77 and PILT NF4.

In certain embodiments, once such a wood pretreatment composition is applied to the cellulose-containing substrate, the composition is dried. In certain embodiments of the present invention, the drying process comprises exposing the wood pretreatment composition to air having a temperature of 10° C. to 50° C., such as 20° C. to 35° C., for a period of at least 30 seconds, such as at least 1 minute, in order to volatilize at least a portion of the volatile material from the wood pretreatment composition and set the composition (hereinafter referred to as the “Pretreatment Flash Step”). As used herein, the term “set” means that an applied composition is tack-free (resists adherence of dust and other airborne contaminants) and is not disturbed or marred (waved or rippled) by air currents which blow past the coated surface. In certain embodiments, the velocity of the air used in the Flash Step is less than 4 meters per second, such as from 0.5 to 4 meters per second and, in some cases, 0.7 to 1.5 meters per second.

The volatilization or evaporation of volatiles from the wood pretreatment composition in the Pretreatment Flash Step can be carried out in the open air or in an oven that includes a Pretreatment Flash Step chamber wherein air is circulated at low velocity to minimize airborne particle contamination. In certain embodiments, the cellulose-containing substrate is positioned at the entrance to the Pretreatment Flash Step chamber and slowly moved therethrough in assembly-line manner at a rate which permits the volatilization of the pretreatment composition, as discussed above. The rate at which the substrate is moved through the Pretreatment Flash Step chamber and the other drying chambers discussed below depends in part upon the length and configuration of the chamber, but, in some cases, ranges from 3 to 10 meters per minute for a continuous process. One skilled in the art would understand that individual dryers can be used for each step of the process or that a single dryer having a plurality of individual chambers or sections configured to correspond to each step of the process can be used, as desired. As used herein, the term “oven” refers to a device that includes one or more chambers in which a composition is baked or dried.

In certain embodiments, the air is supplied to the Pretreatment Flash Step chamber by a blower or dryer. A non-limiting example of a suitable blower is an ALTIVAR 66 blower that is commercially available from Square D Corporation. The air can be circulated at ambient temperature or heated, if necessary, to a desired temperature range, such as 20° C. to 40° C. In certain embodiments, the wood pretreatment composition is exposed to air for a period of 30 seconds to 3 minutes before the substrate is moved to the next stage of the process.

In certain embodiments of the present invention, the drying of the wood pretreatment composition comprises exposing the cellulose-containing substrate simultaneously to warm air and infrared radiation at conditions sufficient to form a pre-dried treatment on and/or within at least a portion of the cellulose-containing substrate (hereinafter referred to as the “First Drying Step”). As used herein, the term “pre-dried treatment” means that the liquid content of the composition is reduced by at least an amount sufficient to result in a substrate surface that is free of any visible puddles of liquid. In certain embodiments, this means that at least 25% of the liquid is removed from the pretreatment composition during the First Drying Step.

In certain embodiments, the First Drying Step comprises applying infrared radiation and low velocity warm air simultaneously to the wood pretreatment composition for a period of at least 1 minute, such as 1 to 3 minutes, such that the temperature of the cellulose-containing substrate is increased at a rate of 0.2° C. to 2° C. per second, such as 0.2° C. to 1.5° C. per second, to, for example, achieve a peak substrate temperature of 25° C. to 120° C., such as 35° C. to 110° C., so as to form a pre-dried wood treatment composition on and/or within at least a portion of the cellulose-containing substrate. As used herein, “peak substrate temperature” means the minimum target temperature to which the cellulose-containing substrate is heated. The peak substrate temperature for a cellulose-containing substrate is measured at the surface of the coated substrate approximately in the middle of the side of the substrate on which the composition is applied and can be measured using any of the known devices used to measure surface temperature, such as an optical pyrometer or a temperature tape.

In certain embodiments, the infrared radiation applied in the First Drying Step includes near-infrared region (0.7 to 1.5 micrometers) and intermediate-infrared region (1.5 to 20 micrometers) radiation, such as from 0.7 to 4 micrometers. The infrared radiation heats the external surfaces of the cellulose-containing substrate which are exposed to the radiation. Most non-external surfaces are not exposed directly to the infrared radiation but will be heated through conduction through the substrate and random scattering of the infrared radiation.

In certain embodiments, the infrared radiation is emitted in the First Drying Step by a plurality of emitters arranged in the interior drying chamber of a combination infrared/convection drying apparatus of the type depicted in FIGS. 2and 3of U.S. Pat. No. 6,200,650, the cited Figures and description thereof being incorporated herein by reference. Each emitter is, in certain embodiments, a high intensity infrared lamp, such as a quartz envelope lamp having a tungsten filament. Useful short wavelength (0.76 to 2 micrometers), high intensity lamps include Model No. T-3 lamps, such as are commercially available from General Electric Co., Sylvania, Phillips, Heraeus and Ushio and have an emission rate of between 75 and 100 watts per lineal inch at the light source. Medium wavelength (2 to 4 micrometers) lamps also can be used and are available from the same suppliers. The emitter lamp is often generally rod-shaped and has a length that can be varied to suit the configuration of the oven, but is often 0.75 to 1.5 meters long. In certain embodiments, the emitter lamps on the side walls of the interior drying chamber are arranged generally vertically with reference to ground, except for a few rows (such as 3 to 5 rows) of emitters at the bottom of the interior drying chamber which are arranged generally horizontally to ground.

The number of emitters can vary depending upon the desired intensity of energy to be emitted. In certain embodiments, 17 to 32 emitters are mounted to the ceiling of the interior drying chamber and arranged in a linear side-by side array with the emitters spaced 15 to 45 centimeters apart from center to center, such as 30 centimeters apart. The width of the interior drying chamber is sufficient to accommodate whatever substrate component is to be dried therein, and, in many cases, is 2.5 to 3.0 meters wide. In certain embodiments, the top section of each side wall of the chamber has 14 to 24 parallel lamps with the lamps spaced 15 to 20 centimeters apart from center to center divided into 6 zones with the emitters spaced 21 to 63 centimeters apart, wherein the three zones nearest the entrance to the drying chamber are operated at medium wavelengths and the three nearest the exit at short wavelengths.

In certain embodiments, each of the emitter lamps is disposed within a trough-shaped reflector that is formed from polished aluminum. Suitable reflectors include aluminum or integral gold-sheathed reflectors that are commercially available from BGK-ITW Automotive, Heraeus and Fannon Products. The reflectors gather energy transmitted from the emitter lamps and focus the energy on the substrate to lessen energy scattering.

In certain embodiments, depending, for example, on the configuration of the substrate, the emitter lamps can be independently controlled by a microprocessor such that the emitter lamps furthest from an exterior surface of the substrate can be illuminated at a greater intensity than lamps closest to such a surface to provide uniform heating.

Also, in order to minimize the distance from the emitter lamps to certain surfaces of the substrate, the position of the side walls and emitter lamps can be adjusted toward or away from the substrate. One skilled in the art would understand that the closer the emitter lamps are to a substrate surface, the greater the percentage of available energy which is applied to heat the surface and compositions present thereon. In certain embodiments, the infrared radiation is emitted in the First Drying Step at an operating power density of 1.0 to 2.5 kilowatts per square meter (kW/m²) of emitter wall surface, such as 1.5 kW/m².

A non-limiting example of a suitable combination infrared/convection drying apparatus is a BGK combined infrared radiation and heated air convection oven, which is commercially available from BGK Automotive Group of Minneapolis, Minn. The general configuration of this oven is disclosed in U.S. Pat. Nos. 4,771,728; 4,907,533; 4,908,231; and 4,943,447, which are hereby incorporated by reference. Other useful combination infrared/convection drying apparatus are commercially available from Durr of Wixom, Mich., Thermal Innovations of Manasquan, N.J., Thermovation Engineering of Cleveland, Ohio, Dry-Quick of Greenburg, Ind. and Wisconsin Oven and Infrared Systems of East Troy, Wis.

In certain embodiments, the combination infrared/convection drying apparatus includes baffled side walls having nozzles or slot openings through which air is passed to enter the interior drying chamber at a velocity of less than 4 meters per second. During the First Drying Step, the velocity of the air at the surface of the substrate is often less than 4 meters per second, such as from 0.5 to 2 meters per second or, in some cases, 0.7 to 1.5 meters per second. In certain embodiments, the temperature of the air used in the First Drying Step ranges from 25° C. to 70° C., such as 30° C. to 60° C. The air may be supplied by a blower or dryer and can be preheated externally or by passing the air over the heated infrared emitter lamps and their reflectors. By passing the air over the emitters and reflectors, the working temperature of these parts can be decreased, thereby extending their useful life. Also, undesirable solvent vapors can be removed from the interior drying chamber. The air can also be circulated up through the interior drying chamber via a subfloor. In certain embodiments, the air flow is recirculated to increase efficiency. A portion of the air flow can be bled off to remove contaminants and supplemented with filtered fresh air to make up for any losses.

In certain embodiments of the present invention, the drying of the wood pretreatment composition comprises exposing the cellulose-containing substrate simultaneously to warm air and infrared radiation at conditions sufficient to form a dried wood pretreatment on and/or within at least a portion of the cellulose-containing substrate (hereinafter referred to as the “Second Drying Step”). As used herein, the term “dried,” when referring to a wood pretreatment composition, means that upon completion of the Second Drying Step most, if not all, of the liquid content of the wood pretreatment composition has been removed. In certain embodiments, this means that upon completion of the Second Drying Step at least 65%, or, in some cases, at least 80%, by weight of the liquid originally in the wood pretreatment composition has been removed from the wood pretreatment composition.

In certain embodiments, the Second Drying Step comprises applying infrared radiation and warm air simultaneously to the wood pretreatment composition for a period of at least 0.5 minutes, such as 0.5 to 2 minutes. In certain embodiments, the temperature of the cellulose-containing substrate is increased in the Second Drying Step at a rate of 0.1° C. per second to 1° C. per second, such as 0.5° C. to 0.7° C., per second, to achieve a peak substrate temperature of 60° C. to 110° C., such as 80° C. to 110° C.

The Second Drying Step can be carried out in a similar manner to that of the First Drying Step described above using a combination infrared radiation/convection drying apparatus, however the rate at which the temperature of the substrate is increased and peak substrate temperature vary as specified.

In certain embodiments, the infrared radiation applied in the Second Drying Step includes near-infrared region (0.7 to 1.5 micrometers) and intermediate-infrared region (1.5 to 20 micrometers) radiation, and, in some cases, ranges from 0.7 to 4 micrometers. In certain embodiments, the infrared radiation is emitted in the Second Drying Step at an operating power density of 2.0 to 4.0 kilowatts per square meter (kW/m²) of emitter wall surface, such as 3.0 kW/m².

In certain embodiments, the warm drying air applied in the Second Drying Step has a temperature of 35° C. to 80° C., such as 60° C. to 70° C. The velocity of the air at the surface of the cellulose-containing substrate in the Second Drying Step is, in certain embodiments, less than 6 meters per second, and, in some cases, ranges from 1 to 4 meters per second.

The Second Drying Step can be carried out using any conventional combination infrared/convection drying apparatus such as the BGK combined infrared radiation and heated air convection oven which is described in detail above. The individual emitters can be configured as discussed above and controlled individually or in groups by a microprocessor to provide the desired heating and infrared energy transmission rates.

By controlling the peak substrate temperature and the rate at which the substrate temperature is increased during the First and Second Drying Steps, flaws in the appearance of the wood pretreatment and subsequently applied compositions, such as pops and bubbles, can be minimized or, in some cases, eliminated. As a result, in certain embodiments of the present invention, the First and Second Drying Steps are conducted at conditions that result in a substantially defect free wood pretreatment applied on at least a portion of the surface of and/or within at least a portion of the cellulose-containing substrate. As used herein, the term “substantially defect free wood pretreatment” means that visual flaws in the appearance of the wood pretreatment composition and any subsequently applied coating compositions, such as pops and bubbles, are at least minimized or, in some cases, eliminated altogether.

In certain embodiments, following the Second Drying Step, an additional drying and/or curing step may be employed, depending upon the presence of any liquid in the wood pretreatment composition after the Second Drying Step and the composition of the wood pretreatment composition itself. For example, and without limitation, in embodiments wherein the wood pretreatment composition includes a radiation curable material, such an ethylenically unsaturated material, an additional curing step may comprise exposing the composition to radiation, such as ultraviolet radiation, as understood by those skilled in the art, to effect crosslinking of crosslinkable components in the composition.

Once a dried wood pretreatment composition is formed, certain embodiments of the present invention comprise a cooling step in which the temperature of the substrate comprising the wood pretreatment thereon is cooled, such as to a temperature of 20° C. to 60° C., such as 25° C. to 30° C. The cooling step may, in certain cases, facilitate application of the next composition to the substrate by preventing a rapid flash of volatiles therein, which can cause poor flow, rough surfaces and generally poor appearance. The substrate can be cooled in air at a temperature of 15° C. to 35° C., such as 25° C. to 30° C. for a period of 15 to 45 minutes. Alternatively or additionally, the substrate can be cooled by exposure to chilled, saturated air blown onto the surface of the substrate at 4 to 10 meters per second to prevent cracking of the coating.

Suitable colorizing compositions that may be applied to a cellulose-containing substrate in accordance with the present invention include wood stain and/or toner compositions. As used herein, the term “stain” refers to a translucent composition that can color a cellulose-containing substrate while allowing some of the substrate's natural color and grain to show through. As used herein, the term “toner” refers to a composition that performs a function similar to a stain, however, a “toner” is typically a low solids composition (no more than 5 weight percent solids and at least 95 weight percent solvent) and is typically applied to a substrate at a low film thickness before a stain is applied. Suitable wood stain and/or toner compositions include, without limitation, the compositions described in U.S. patent application Ser. No. 11/096,847 at [0015] to [0043], the cited portion of which being incorporated by reference herein.

In certain embodiments, once such a colorizing composition is applied to the cellulose-containing substrate, the composition is dried to form a colorizing coating on the substrate. In certain embodiments, such drying is conducted by conventional hot air convection drying or infrared drying.

In certain embodiments of the present invention, the drying process comprises exposing the colorizing coating composition to air having a temperature of 10° C. to 50° C., such as 20° C. to 35° C., for a period of at least 30 seconds, such as at least 1 minute, in order to volatilize at least a portion of any volatile material that may be present in the colorizing coating composition and set the composition (hereinafter referred to as the “Colorizing Coating Flash Step”). In certain embodiments, the velocity of the air used in the Colorizing Coating Flash Step is less than 4 meters per second, such as from 0.5 to 4 meters per second and, in some cases, 0.7 to 1.5 meters per second.

The volatilization or evaporation of volatiles from the colorizing coating composition in the Colorizing Coating Flash Step can be carried out in the open air or in a Colorizing Coating Flash Step chamber (which may be the same or different than the Pretreatment Flash Step chamber described earlier) wherein air is circulated at low velocity to minimize airborne particle contamination, such as was described earlier with respect to the Pretreatment Flash Step.

In certain embodiments, the air is supplied to the Colorizing Coating Flash Step chamber by a blower or dryer, such as was described earlier with respect to the Pretreatment Flash Step.

In certain embodiments of the present invention, the drying of the colorizing coating composition comprises exposing the cellulose-containing substrate simultaneously to warm air and infrared radiation at conditions sufficient to form a pre-dried colorizing coating on and/or within at least a portion of the cellulose-containing substrate (hereinafter referred to as the “First Colorizing Coating Drying Step”). As used herein, the term “pre-dried colorizing coating” means that the liquid content of the colorizing coating composition is reduced by at least an amount sufficient to result in a substrate surface that is free of any visible puddles of liquid. In certain embodiments, this means that at least 25% of the liquid is removed from the colorizing coating composition during the First Colorizing Coating Drying Step.

In certain embodiments, the First Colorizing Coating Drying Step comprises applying infrared radiation and low velocity warm air simultaneously to the colorizing coating composition for a period of at least 1 minute, such as 1 to 3 minutes, such that the temperature of the cellulose-containing substrate is increased at a rate of 0.2° C. to 2° C. per second, such as 0.2° C. to 1.5° C. per second, to, for example, achieve a peak substrate temperature of 25° C. to 120° C., such as 35° C. to 110° C., so as to form a pre-dried colorizing coating on and/or within at least a portion of the cellulose-containing substrate.

In certain embodiments, the infrared radiation applied in the First Colorizing Coating Drying Step includes near-infrared region (0.7 to 1.5 micrometers) and intermediate-infrared region (1.5 to 20 micrometers) radiation, such as from 0.7 to 4 micrometers.

In certain embodiments, the infrared radiation is emitted in the First Colorizing Coating Drying Step by a plurality of emitters arranged in the interior drying chamber of a combination infrared/convection drying apparatus of the type described earlier with respect to the drying of a wood pretreatment composition. In certain embodiments, the infrared radiation is emitted in the First Colorizing Coating Drying Step at a power density of 1.0 to 2.5 kilowatts per square meter (kW/m²) of emitter wall surface, such as 1.5 kW/m².

In certain embodiments, the combination infrared/convection drying apparatus includes baffled side walls having nozzles or slot openings through which air is passed to enter the interior drying chamber at a velocity of less than 4 meters per second. During the First Colorizing Coating Drying Step, the velocity of the air at the surface of the substrate is often less than 4 meters per second, such as from 0.5 to 2 meters per second or, in some cases, 0.7 to 1.5 meters per second. In certain embodiments, the temperature of the air used in the First Colorizing Coating Drying Step ranges from 25° C. to 70° C., such as 30° C. to 60° C. The air may be supplied by a blower or dryer and can be preheated externally or by passing the air over the heated infrared emitter lamps and their reflectors, as described above with respect to the wood pretreatment composition.

In certain embodiments of the present invention, the drying of the colorizing coating composition comprises exposing the cellulose-containing substrate simultaneously to warm air and infrared radiation at conditions sufficient to form a dried colorizing coating on and/or within at least a portion of the cellulose-containing substrate (hereinafter referred to as the “Second Colorizing Coating Drying Step”). As used herein, the term “dried colorizing coating,” means that upon completion of the Second Colorizing Coating Drying Step most, if not all, of the liquid content of the colorizing coating composition has been removed. In certain embodiments, this means that upon completion of the Second Colorizing Coating Drying Step at least 65%, or, in some cases, at least 80%, by weight of the liquid originally in the colorizing coating composition has been removed therefrom.

In certain embodiments, the Second Colorizing Coating Drying Step comprises applying infrared radiation and warm air simultaneously to the treatment composition for a period of at least 0.5 minutes, such as 0.5 to 2 minutes. In certain embodiments, the temperature of the cellulose-containing substrate is increased in the Second Colorizing Coating Drying Step at a rate of 0.1° C. to 1° C. per second, such as 0.5° C. to 0.7° C. per second, to achieve a peak substrate temperature of 60° C. to 110° C., such as 80° C. to 110° C.

The Second Colorizing Coating Drying Step can be carried out in a similar manner to that of the First Colorizing Coating Drying Step described above using a combination infrared radiation/convection drying apparatus, however the rate at which the temperature of the substrate is increased and peak substrate temperature vary as specified.

In certain embodiments, the infrared radiation applied in the Second Colorizing Coating Drying Step includes near-infrared region (0.7 to 1.5 micrometers) and intermediate-infrared region (1.5 to 20 micrometers) radiation, and, in some cases, ranges from 0.7 to 4 micrometers. In certain embodiments, the infrared radiation is emitted in the Second Colorizing Coating Drying Step at an operating power density of 2.0 to 4.0 kilowatts per square meter (kW/m²) of emitter wall surface, such as 3.0 kW/m².

In certain embodiments, the warm drying air applied in the Second Colorizing Coating Drying Step has a temperature of 35° C. to 80° C., such as 60° C. to 70° C. The velocity of the air at the surface of the cellulose-containing substrate in the Second Colorizing Coating Drying Step is, in certain embodiments, less than 6 meters per second, and, in some cases, ranges from 1 to 4 meters per second.

The Second Colorizing Coating Drying Step can be carried out using any conventional combination infrared/convection drying apparatus such as the BGK combined infrared radiation and heated air convection oven which is described in detail above. The individual emitters can be configured as discussed above and controlled individually or in groups by a microprocessor to provide the desired heating and infrared energy transmission rates.

By controlling the peak substrate temperature and the rate at which the substrate temperature is increased during the First and Second Colorizing Coating Drying Steps, flaws in the appearance of the colorizing coating and subsequently applied compositions, such as pops and bubbles, can be minimized or, in some cases, eliminated. As a result, in certain embodiments of the present invention, the First and Second Colorizing Coating Drying Steps are conducted at conditions that result in a substantially defect free colorizing coating applied on at least a portion of the surface of and/or within at least a portion of the cellulose-containing substrate. As used herein, the term “substantially defect free colorizing coating” means that visual flaws in the appearance of the colorizing coating and any subsequently applied coating compositions, such as pops and bubbles, are at least minimized or, in some cases, eliminated altogether.

In certain embodiments, following the Second Colorizing Coating Drying Step, an additional drying and/or curing step may be employed, depending upon the presence of any liquid in the colorizing coating composition after the Second Colorizing Coating Drying Step and the composition of the colorizing coating composition itself. For example, and without limitation, in embodiments wherein the colorizing coating composition includes a radiation curable material, such an ethylenically unsaturated material, an additional curing step may comprise exposing the composition to radiation, such as ultraviolet radiation, as understood by those skilled in the art, to effect crosslinking of crosslinkable components in the composition.

Once a colorizing coating is formed, certain embodiments of the present invention comprise a cooling step in which the temperature of the substrate having the dried colorizing coating thereon is cooled, such as to a temperature of 20° C. to 60° C., such as 25° C. to 30° C. The cooling step may, in certain cases, facilitate application of the next composition to the substrate by preventing a rapid flash of volatiles in such a composition that can cause poor flow, rough surfaces and generally poor appearance. The substrate can be cooled in air at a temperature of 15° C. to 35° C., such as 25° C. to 30° C. for a period of 15 to 45 minutes. Alternatively or additionally, the substrate can be cooled by exposure to chilled, saturated air blown onto the surface of the substrate at 4 to 10 meters per second to prevent cracking of the coating.

Suitable intermediate coating compositions that may be applied to a cellulose-containing substrate in accordance with the present invention include, for example, any composition that provides a protective layer that at least partially seals the wood surface thereby at least partially preventing subsequently applied coatings from staining the substrate. In addition, such intermediate coatings may, in certain embodiments, be sanded to provide a smooth finish for application of subsequent coating layers. In many cases, an intermediate coating composition is necessary due to the porous surface characteristics of a cellulose-containing substrate. The intermediate coating layer may work to seal the substrate surface from exposure to the elements and additionally to fill various fissures and crevices in the surface.

Examples of suitable intermediate coating compositions that may be applied to a cellulose-containing substrate in accordance with the present invention include single component and multi-component liquid (both solventborne and waterborne), powder slurry, and/or powder (solid) compositions, as desired. Suitable liquid or powder slurry intermediate coating compositions include, for example, those compositions that include a film-forming resin, a volatile material and, optionally, pigments and other additives. Volatile materials are absent from powder compositions.

In certain embodiments, the intermediate coating composition, regardless of form, comprises a thermosetting film-forming resin, such as a thermosetting polyurethane, acrylic, polyester, and/or epoxy resin in combination with a crosslinking agent; an alkyd resin; an ethylenically unsaturated resin, such as acrylates, or maleic or vinyl ether unsaturation; and/or a radiation curable epoxy resin. In certain embodiments, such an intermediate coating composition is selected from a two-component system based on a polyurethane and/or an epoxy resin, based on alkyd resins dissolved in solvent, or based on copolymers dissolved in solvents. In other embodiments, however, the intermediate coating composition comprises a thermoplastic film-forming resin, such as a polyolefin. As used herein, the term “thermoplastic” refers to resins that comprise polymeric components that are not joined by covalent bonds and thereby can undergo liquid flow upon heating and are soluble in solvents. See Saunders, K.J., Organic Polymer Chemistry, pp. 41-42, Chapman and Hall, London (1973). As used herein, the term “thermosetting” refers to resins that harden upon curing or crosslinking, wherein the polymer chains of the polymeric components are joined together by covalent bonds. This property is usually associated with a cross-linking reaction of the composition constituents often induced, for example, by heat or radiation. See Hawley, Gessner G., The Condensed Chemical Dictionary, Ninth Edition., page 856; Surface Coatings, vol. 2, Oil and Colour Chemists' Association, Australia, TAFE Educational Books (1974). Curing or crosslinking reactions also may be carried out under ambient conditions. Once cured or crosslinked, a thermosetting resin will not melt upon the application of heat and is insoluble in solvents. In this application, when referring to a composition that includes a thermosetting film-forming resin, the word “dry,” in any form, such as “drying process”, is meant to include not only the removal of volatile components from the composition but also at least partial curing, i.e., at least partial crosslinking, of the crosslinkable components of the composition.

Specific non-limiting examples of suitable intermediate coating compositions include, for example, two component solvent-based urethanes and compositions including tannin blocking components. Suitable polyurethanes include the reaction products of polymeric polyols, such as polyester polyols or acrylic polyols, with a polyisocyanate, such as an aromatic diisocyanate, such as 4,4′-diphenylmethane diisocyanate, aliphatic diisocyanates, such as 1,6-hexamethylene diisocyanate, and cycloaliphatic diisocyanates such as isophorone diisocyanate and 4,4′-methylene-bis(cyclohexyl isocyanate). Suitable acrylic polymers include polymers of acrylic acid, methacrylic acid and alkyl esters thereof. Other useful film-forming materials and other components for primers are disclosed in U.S. Pat. Nos. 4,971,837; 5,492,731 and 5,262,464. In certain embodiments, the amount of film-forming material in the intermediate coating composition ranges from 37 to 60 weight percent on a basis of total resin solids weight of the coating composition.

Suitable crosslinking materials include aminoplasts, polyisocyanates (discussed above) and mixtures thereof. Useful aminoplast resins are based on the addition products of formaldehyde, with an amino- or amido-group carrying substance. Condensation products obtained from the reaction of alcohols and formaldehyde with melamine, urea or benzoguanamine are most common. In certain embodiments, the amount of the crosslinking material in the primer coating composition ranges from 5 to 50 weight percent on a basis of total resin solids weight of the primer coating composition.

Volatile materials which can be included in the liquid or powder slurry intermediate coating composition include water and/or organic solvents, such as alcohols including methanol, propanol, ethanol, butanol, butyl alcohol and hexyl alcohol; ethers and ether alcohols, such as ethyleneglycol monoethyl ether, ethyleneglycol monobutyl ether; ketones such as methyl ethyl ketone and methyl isobutyl ketone; esters such as butyl acetate; aliphatic and alicyclic hydrocarbons such as petroleum naphthas; and aromatic hydrocarbons such as toluene and xylene. The amount of volatile material in the intermediate coating composition often ranges from 1 to 30 weight percent on a total weight basis of the intermediate coating composition.

Other additives, such as plasticizers, antioxidants, mildewcides, fungicides, surfactants, fillers and pigments, can be present in the intermediate coating composition in amounts generally up to 40 weight percent. Useful fillers and pigments are disclosed in U.S. Pat. No. 4,971,837, which is incorporated herein by reference. For the liquid and powder slurry intermediate coating compositions, the weight percent solids of the coating often ranges from 30 to 80 weight percent on a total weight basis.

Waterborne intermediate coating compositions have come into widespread use and are suitable for use in the present invention. Resins suitable for use in such compositions include, for example, water-dilutable vinyl polymers, such as is disclosed in U.S. Pat. No. 3,847,857, 5,286,778 and 5,395,436, alkyds and maleinized linseed oils, which may employ glycol ethers as coupling solvents in combination with alkaline neutralizers to assure solubility of the resin component in water, as well as acrylic and vinyl acrylic polymers prepared by emulsion polymerization. Also suitable are waterborne coating compositions comprising radiation curable resins, such as those resins comprising ethylenic unsaturation.

In certain embodiments, once such a liquid intermediate coating is applied to the cellulose-containing substrate, the composition is dried to form an intermediate coating on the substrate. In certain embodiments, such drying is often conducted by conventional hot air convection drying or infrared drying.

In certain embodiments of the present invention, the drying process comprises exposing the liquid intermediate coating composition to air having a temperature of 10° C. to 50° C., such as 20° C. to 35° C., for a period of at least 30 seconds, such as at least 1 minute, in order to volatilize at least a portion of any volatile material that may be present in the intermediate coating composition and set the composition (hereinafter referred to as the “Intermediate Coating Flash Step”). In certain embodiments, the velocity of the air used in the Intermediate Coating Flash Step is less than 4 meters per second, such as from 0.5 to 4 meters per second and, in some cases, 0.7 to 1.5 meters per second.

The volatilization or evaporation of volatiles from the intermediate coating composition in the Intermediate Coating Flash Step can be carried out in the open air or in an Intermediate Coating Flash Step chamber (which may be the same or different than the Pretreatment Flash Step chamber described earlier) wherein air is circulated at low velocity to minimize airborne particle contamination, such as was described earlier with respect to the Pretreatment Flash Step.

In certain embodiments, the air is supplied to the Intermediate Coating Flash Step chamber by a blower or dryer, such as was described earlier with respect to the Pretreatment Flash Step.

In certain embodiments of the present invention, the drying of the liquid intermediate coating composition comprises exposing the cellulose-containing substrate simultaneously to warm air and infrared radiation at conditions sufficient to form a pre-dried intermediate coating on and/or within at least a portion of the cellulose-containing substrate (hereinafter referred to as the “First Intermediate Coating Drying Step”). As used herein, the term “pre-dried intermediate coating” means that the liquid content of the composition is reduced by at least an amount sufficient to result in a substrate surface that is free of any visible puddles of liquid. In certain embodiments, this means that at least 25% of the liquid is removed from the intermediate coating composition during the First Intermediate Coating Drying Step.

In certain embodiments, the First Intermediate Coating Drying Step comprises applying infrared radiation and low velocity warm air simultaneously to the intermediate coating composition for a period of at least 1 minute, such as 1 to 3 minutes, such that the temperature of the cellulose-containing substrate is increased at a rate of 0.2° C. to 2° C. per second, such as 0.2° C. to 1.5° C. per second, to achieve a peak substrate temperature of 30° C. to 120° C., such as 35° C. to 110° C., so as to form a pre-dried intermediate coating on and/or within at least a portion of the cellulose-containing substrate.

In certain embodiments, the infrared radiation applied in the First Intermediate Coating Drying Step includes near-infrared region (0.7 to 1.5 micrometers) and intermediate-infrared region (1.5 to 20 micrometers) radiation, such as from 0.7 to 4 micrometers.

In certain embodiments, the infrared radiation is emitted in the First Intermediate Coating Drying Step by a plurality of emitters arranged in the interior drying chamber of a combination infrared/convection drying apparatus of the type described earlier with respect to the drying of a wood pretreatment composition. In certain embodiments, the infrared radiation is emitted in the First Intermediate Coating Drying Step at an operating power density of 1.0 to 2.5 kilowatts per square meter (kW/m²) of emitter wall surface, such as 1.5 kW/m².

In certain embodiments, the combination infrared/convection drying apparatus includes baffled side walls having nozzles or slot openings through which air is passed to enter the interior drying chamber at a velocity of less than 4 meters per second. During the First Intermediate Coating Drying Step, the velocity of the air at the surface of the substrate is often less than 4 meters per second, such as from 0.5 to 2 meters per second or, in some cases, 0.7 to 1.5 meters per second. In certain embodiments, the temperature of the air used in the First Intermediate Coating Drying Step ranges from 25° C. to 70° C., such as 30° C. to 60° C. The air may be supplied by a blower or dryer and can be preheated externally or by passing the air over the heated infrared emitter lamps and their reflectors, as described above with respect to the wood pretreatment composition.

In certain embodiments of the present invention, the drying of the intermediate coating composition comprises exposing the cellulose-containing substrate simultaneously to warm air and infrared radiation at conditions sufficient to form a dried intermediate coating on and/or within at least a portion of the cellulose-containing substrate (hereinafter referred to as the “Second Intermediate Coating Drying Step”). As used herein, the term “dried,” when referring to an intermediate coating composition, means that upon completion of the Second Intermediate Coating Drying Step most, if not all, of the liquid content of the intermediate coating composition has been removed. In certain embodiments, this means that upon completion of the Second Intermediate Coating Drying Step at least 65%, or, in some cases, at least 80%, by weight of the liquid originally in the intermediate coating composition has been removed from the wood pretreatment composition. In certain embodiments, the term “dried intermediate coating,” also means that the coating exhibits a pencil hardness of at least 2B (measured according to ASTM D3363-92A) and/or, when subjected to double rubs with a cloth soaked in methyl ethyl ketone, will endure at least 10 double rubs without removing the coating.

In certain embodiments, the Second Intermediate Coating Drying Step comprises applying infrared radiation and warm air simultaneously to the treatment composition for a period of at least 0.5 minutes, such as 0.5 to 2 minutes. In certain embodiments, the temperature of the cellulose-containing substrate is increased in the Second Intermediate Coating Drying Step at a rate of 0.1° C. to 1° C. per second, such as 0.5° C. to 0.7° C. per second, to achieve a peak substrate temperature of 40° C. to 120° C., such as 80° C. to 110° C.

The Second Intermediate Coating Drying Step can be carried out in a similar manner to that of the First Intermediate Coating Drying Step described above using a combination infrared radiation/convection drying apparatus, however the rate at which the temperature of the substrate is increased and peak substrate temperature vary as specified.

In certain embodiments, the infrared radiation applied in the Second Intermediate Coating Drying Step includes near-infrared region (0.7 to 1.5 micrometers) and intermediate-infrared region (1.5 to 20 micrometers) radiation, and, in some cases, ranges from 0.7 to 4 micrometers. In certain embodiments, the infrared radiation is emitted in the Second Intermediate Coating Drying Step at an operating power density of 4.0 to 10.0 kilowatts per square meter (kW/m²) of emitter wall surface.

In certain embodiments, the warm drying air applied in the Second Intermediate Coating Drying Step has a temperature of 35° C. to 80° C., such as 50° C. to 75° C. The velocity of the air at the surface of the cellulose-containing substrate in the Second Intermediate Coating Drying Step is, in certain embodiments, less than 6 meters per second, and, in some cases, ranges from 1 to 4 meters per second.

The Second Intermediate Coating Drying Step can be carried out using any conventional combination infrared/convection drying apparatus such as the BGK combined infrared radiation and heated air convection oven which is described in detail above. The individual emitters can be configured as discussed above and controlled individually or in groups by a microprocessor to provide the desired heating and infrared energy transmission rates.

By controlling the peak substrate temperature and the rate at which the substrate temperature is increased during the First and Second Intermediate Coating Drying Steps, flaws in the appearance of the intermediate coating and subsequently applied compositions, such as pops and bubbles, can be minimized or, in some cases, eliminated. As a result, in certain embodiments of the present invention, the First and Second Intermediate Coating Drying Steps are conducted at conditions that result in a substantially defect free intermediate coating applied on at least a portion of the surface of and/or within at least a portion of the cellulose-containing substrate. As used herein, the term “substantially defect free intermediate coating” means that visual flaws in the appearance of the intermediate coating composition and any subsequently applied coating compositions, such as pops and bubbles, are at least minimized or, in some cases, eliminated altogether.

As indicated, in certain embodiments, the intermediate coating that is formed upon the surface of and/or within the cellulose-containing substrate is dried sufficiently to enable application of subsequent coatings such that the quality of any subsequently applied compositions will not be affected adversely by further drying of the intermediate coating composition. As used herein, the term “dried sufficiently” when referring to an intermediate coating, means that the coating exhibits a pencil hardness of at least 2B (measured according to ASTM D3363-92A) and/or, when subjected to double rubs with a cloth soaked in methyl ethyl ketone will endure at least 10 double rubs without removing the coating.

In certain embodiments, following the Second Intermediate Coating Drying Step, an additional drying and/or curing step may be employed, depending upon the presence of any liquid in the intermediate coating composition after the Second Intermediate Coating Drying Step and the composition of the intermediate coating composition itself. For example, and without limitation, in embodiments wherein the intermediate coating composition includes a radiation curable material, such an ethylenically unsaturated material, an additional curing step may comprise exposing the composition to radiation, such as ultraviolet radiation, as understood by those skilled in the art, to effect crosslinking of crosslinkable components in the composition.

Once an intermediate coating is formed, certain embodiments of the present invention comprise a cooling step in which the temperature of the substrate having the dried intermediate coating thereon is cooled, such as to a temperature of 20° C. to 60° C., such as 25° C. to 30° C. The cooling step may, in certain cases, facilitate application of the next composition to the substrate by preventing a rapid flash of volatiles in the next composition that can cause poor flow, rough surfaces and generally poor appearance. The substrate can be cooled in air at a temperature of 15° C. to 35° C., such as 25° C. to 30° C. for a period of 15 to 45 minutes. Alternatively or additionally, the substrate can be cooled by exposure to chilled, saturated air blown onto the surface of the substrate at 4 to 10 meters per second to prevent cracking of the coating.

Suitable topcoat coating compositions that may be applied to a cellulose-containing substrate in accordance with the present invention include any composition that provides a decorative and protective layer that is capable of resisting damage caused by environmental conditions. In certain embodiments, the topcoat coating composition comprises a single coating composition that is used to form a single coating layer, such as a pigmented or clear topcoat whereas, in other embodiments, the topcoat coating composition comprises two or more coating compositions, such as a pigmented basecoat coating composition and a clearcoat coating composition, which are used to form a multi-component composite topcoating.

Examples of suitable topcoat coating compositions that may be applied to a cellulose-containing substrate in accordance with the present invention include single component and/or multi-component liquid (both solventborne and waterborne), powder slurry, and/or powder (solid) compositions, as desired. Suitable liquid or powder slurry topcoat coating compositions include, for example, those compositions that include a film-forming resin, a volatile material and, optionally, pigments and other additives. Volatile materials are absent from powder compositions.

As previously indicated, in certain embodiments, the topcoat coating compositions comprises two or more coating compositions, such as a pigmented basecoat coating composition and a clearcoat coating composition. Suitable liquid basecoat coating compositions include, for example, those that comprise a film-forming material or binder, volatile material and pigment, whereas suitable liquid clearcoat coating compositions include, for example, those that comprise a film-forming material or binder and volatile material, but no color-imparting pigment. In certain embodiments, the topcoat coating composition, such as the basecoat coating composition or clearcoat coating composition, is a crosslinkable coating composition comprising at least one thermosettable film-forming material, such as acrylics, polyesters (including alkyds), polyurethanes and epoxies, and at least one crosslinking material, such as are discussed above. Thermoplastic film-forming materials such as polyolefins, vinyls, acrylics, polyesters, and/or polyurethanes also can be used. In certain embodiments, the amount of film-forming material in the topcoat coating composition is from 40 to 97 weight percent on a basis of total solids of the topcoat coating composition. In certain embodiments, the amount of crosslinking material in the topcoating composition is from 5 to 50 weight percent on a basis of total resin solids weight of the topcoating composition.

Suitable acrylic film-forming polymers include, for example, copolymers of one or more of acrylic acid, methacrylic acid and alkyl esters thereof, such as methyl methacrylate, ethyl methacrylate, hydroxyethyl methacrylate, butyl methacrylate, ethyl acrylate, hydroxyethyl acrylate, butyl acrylate and 2-ethylhexyl acrylate, optionally together with one or more other polymerizable ethylenically unsaturated monomers, including vinyl aromatic compounds, such as styrene and vinyl toluene, nitriles such as acrylonitrile and methacrylonitrile, vinyl and vinylidene halides, and vinyl esters such as vinyl acetate.

Polyesters and alkyds are other examples of resinous binders useful for preparing the topcoat coating composition. Such polymers can be prepared in a known manner by condensation of polyhydric alcohols, such as ethylene glycol, propylene glycol, butylene glycol, 1,6-hexylene glycol, neopentyl glycol, trimethylolpropane and pentaerythritol, with polycarboxylic acids, such as adipic acid, maleic acid, fumaric acid, phthalic acids, trimellitic acid or drying oil fatty acids.

Polyurethanes also can be used as the resinous binder of the topcoat coating composition. Useful polyurethanes include the reaction products of polymeric polyols, such as polyester polyols or acrylic polyols with a polyisocyanate, including aromatic diisocyanates such as 4,4′-diphenylmethane diisocyanate, aliphatic diisocyanates, such as 1,6-hexamethylene diisocyanate, and cycloaliphatic diisocyanates, such as isophorone diisocyanate and 4,4′-methylene-bis(cyclohexyl isocyanate).

A liquid topcoat coating composition may comprise one or more volatile materials, such as water, organic solvents and/or amines. Nonlimiting examples of useful solvents include aliphatic solvents, such as hexane, naphtha, and mineral spirits; aromatic and/or alkylated aromatic solvents, such as toluene, xylene, and SOLVESSO 100; alcohols, such as ethyl, methyl, n-propyl, isopropyl, n-butyl, isobutyl and amyl alcohol, and m-pyrol; esters, such as ethyl acetate, n-butyl acetate, isobutyl acetate and isobutyl isobutyrate; ketones, such as acetone, methyl ethyl ketone, methyl isobutyl ketone, diisobutyl ketone, methyl n-amyl ketone, and isophorone, glycol ethers and glycol ether esters, such as ethylene glycol monobutyl ether, diethylene glycol monobutyl ether, ethylene glycol monohexyl ether, propylene glycol monomethyl ether, propylene glycol monopropyl ether, ethylene glycol monobutyl ether acetate, propylene glycol monomethyl ether acetate, and dipropylene glycol monomethyl ether acetate. Useful amines include alkanolamines. In certain embodiments, the solids content of the topcoat coating composition is 15 to 60 weight percent, such as 20 to 50 weight percent, based on the total weight of the composition.

The topcoat coating composition can further comprise one or more additives, such as pigments, fillers, UV absorbers, rheology control agents, catalysts, initiators, such as photoinitiators, and/or surfactants. Useful pigments and fillers include aluminum flake, bronze flakes, coated mica, nickel flakes, tin flakes, silver flakes, copper flakes, mica, iron oxides, lead oxides, carbon black, titanium dioxide, talc, silica, and other metal oxides, as well as other known organic and inorganic pigments. The specific pigment to binder ratio can vary widely so long as it provides the requisite hiding at the desired film thickness and application solids.

Waterborne topcoat coating compositions are suitable for use in the present invention. Resins suitable for use in such compositions include, for example, water-dilutable vinyl polymers, such as is disclosed in U.S. Pat. No. 3,847,857, 5,286,778 and 5,395,436, alkyds and maleinized linseed oils, which may employ glycol ethers as coupling solvents in combination with alkaline neutralizers to assure solubility of the resin component in water, as well as acrylic and vinyl acrylic polymers prepared by emulsion polymerization, waterborne acrylics, polyurethanes, and/or ethylenically unsaturated materials.

The thickness of the topcoat coating composition applied to the substrate can vary based upon such factors as the type of substrate and intended use of the substrate, i.e., the environment in which the substrate is to be placed and the nature of the contacting materials. In certain embodiments, the thickness of the topcoat coating composition applied to the substrate is 10 to 250 micrometers, such as 12 to 150 micrometers.

As previously mentioned, in certain embodiments, the topcoating comprises a liquid pigmented basecoat coating and a clearcoat coating, which form a multi-component composite topcoating. In such embodiments, a liquid basecoat coating composition may first be applied to the cellulose-containing substrate. In certain embodiments, such a basecoat coating composition is then dried by exposing the composition to low velocity air to volatilize at least a portion of the volatile material from the composition and set the composition. In certain embodiments, the drying process comprises exposing the basecoat coating composition to air having a temperature of 10° C. to 50° C. for a period of at least 30 seconds, such as at least 1 minute, to volatilize at least a portion of any volatile material that may be present in the basecoating composition and set the composition (“hereinafter referred to as the “Basecoating Flash Step”). In certain embodiments, the velocity of the air used in the Basecoating Flash Step is less than 4 meters per second, such as from 0.5 to 4 meters per second and, in some cases, 0.7 to 1.5 meters per second.

The volatilization or evaporation of volatiles from the basecoat coating composition in the Basecoating Flash Step can be carried out in the open air, or, in some cases, is carried out in an Basecoating Flash Step chamber (which may be the same or different than the Pretreatment Flash Step chamber described earlier) wherein air is circulated at low velocity to minimize airborne particle contamination. In certain embodiments, the cellulose-containing substrate is positioned at the entrance to the Basecoating Flash Step chamber and slowly moved therethrough in assembly-line manner at a rate which permits the volatilization of volatile materials in the basecoat coating composition, as discussed above. The rate at which the substrate is moved through the Basecoating Flash Step chamber and the other drying chambers discussed below depends in part upon the length and configuration of the chamber, but, in some cases, is 1 to 10 meters per minute for a continuous process. One skilled in the art would understand that individual dryers can be used for each step of the process or that a single dryer having a plurality of individual chambers or sections configured to correspond to each step of the process can be used, as desired.

In certain embodiments, the air is supplied to the Basecoating Flash Step chamber by a blower or dryer, such as was described earlier with respect to the Flash Step associated with the wood pretreatment composition.

In certain embodiments of the present invention, the drying of the basecoat coating composition comprises exposing the cellulose-containing substrate simultaneously to warm air and infrared radiation at conditions sufficient to form a pre-dried basecoating on the surface of and/or within the cellulose-containing substrate (hereinafter referred to as the “First Basecoating Drying Step”). As used herein, the term “pre-dried basecoating” means that the liquid content of the liquid basecoat composition is reduced by at least an amount sufficient to result in a substrate surface that is free of any visible puddles of liquid. In certain embodiments, this means that at least 25% of the liquid is removed from the liquid basecoating composition during the First Basecoating Drying Step.

In certain embodiments, the First Basecoating Drying Step comprises applying infrared radiation and low velocity warm air simultaneously to the basecoat coating composition for a period of at least 1 minute, such as 1 to 3 minutes, such that the temperature of the cellulose-containing substrate is increased at a rate of 0.2° C. to 2° C. per second, such as 0.2° C. to 1.5° C. per second, to achieve a peak substrate temperature of 30° C. to 120° C., such as 35° C. to 110° C., so as to form a pre-dried basecoating on the surface of and/or within the cellulose-containing substrate.

In certain embodiments, the infrared radiation applied in the First Basecoating Drying Step includes near-infrared region (0.7 to 1.5 micrometers) and intermediate-infrared region (1.5 to 20 micrometers) radiation, such as from 0.7 to 4 micrometers.

In certain embodiments, the infrared radiation is emitted in the First Basecoating Drying Step by a plurality of emitters arranged in the interior drying chamber of a combination infrared/convection drying apparatus of the type described earlier with respect to the drying of a wood pretreatment composition. In certain embodiments, the infrared radiation is emitted in the First Basecoating Drying Step at an operating power density of 1.0 to 2.5 kilowatts per square meter (kW/m²) of emitter wall surface.

In certain embodiments, the combination infrared/convection drying apparatus includes baffled side walls having nozzles or slot openings through which air is passed to enter the interior drying chamber at a velocity of less than 4 meters per second. During the First Basecoating Drying Step, the velocity of the air at the surface of the substrate is often less than 4 meters per second, such as from 0.5 to 2 meters per second or, in some cases, 0.7 to 1.5 meters per second. In certain embodiments, the temperature of the air used in the First Basecoating Drying Step ranges from 25° C. to 70° C., such as 30° C. to 70° C. The air may be supplied by a blower or dryer and can be preheated externally or by passing the air over the heated infrared emitter lamps and their reflectors, as described above with respect to the wood pretreatment composition.

In certain embodiments of the present invention, the drying of the basecoating composition comprises exposing the cellulose-containing substrate simultaneously to warm air and infrared radiation at conditions sufficient to form a dried basecoating on and/or within at least a portion of the cellulose-containing substrate (hereinafter referred to as the “Second Basecoating Drying Step”). As used herein, the term “dried,” when referring to a liquid basecoating coating composition, means that upon completion of the Second Basecoating Coating Drying Step most, if not all, of the liquid content of the basecoat coating composition has been removed. In certain embodiments, this means that upon completion of the Second Basecoating Coating Drying Step at least 65%, or, in some cases, at least 80%, by weight of the liquid originally in the liquid basecoat coating composition has been removed therefrom. In certain embodiments, the term “dried basecoating,” also means that the basecoating exhibits a pencil hardness of at least 2B (measured according to ASTM D3363-92A) and/or, when subjected to double rubs with a cloth soaked in methyl ethyl ketone, will endure at least 10 double rubs without removing the coating.

In certain embodiments, the Second Basecoating Drying Step comprises applying infrared radiation and warm air simultaneously to the treatment composition for a period of at least 0.5 minutes, such as 0.5 to 3 minutes. In certain embodiments, the temperature of the cellulose-containing substrate is increased in the Second Basecoating Drying Step at a rate of 0.1° C. to 1° C. per second, such as 0.5° C. to 0.7° C., per second, to achieve a peak substrate temperature of 40° C. to 120° C., such as 60° C. to 110° C.

The Second Basecoating Drying Step can be carried out in a similar manner to that of the First Basecoating Drying Step described above using a combination infrared radiation/convection drying apparatus, however the rate at which the temperature of the substrate is increased and peak substrate temperature vary as specified.

In certain embodiments, the infrared radiation applied in the Second Basecoating Drying Step includes near-infrared region (0.7 to 1.5 micrometers) and intermediate-infrared region (1.5 to 20 micrometers) radiation, and, in some cases, ranges from 0.7 to 4 micrometers. In certain embodiments, the infrared radiation is emitted in the Second Basecoating Drying Step at an operating power density of 2 to 10 kilowatts per square meter (kW/m²) of emitter wall surface.

In certain embodiments, the warm drying air applied in the Second Basecoating Drying Step has a temperature of 35° C. to 110° C., such as 50° C. to 90° C. The velocity of the air at the surface of the cellulose-containing substrate in the Second Basecoating Drying Step is, in certain embodiments, less than 6 meters per second, and, in some cases, ranges from 1 to 4 meters per second.

The Second Basecoating Drying Step can be carried out using any conventional combination infrared/convection drying apparatus such as the BGK combined infrared radiation and heated air convection oven which is described in detail above. The individual emitters can be configured as discussed above and controlled individually or in groups by a microprocessor provide the desired heating and infrared energy transmission rates.

By controlling the peak substrate temperature and the rate at which the substrate temperature is increased during the First and Second Basecoating Drying Steps, flaws in the appearance of the basecoating and any subsequently applied topcoating composition, such as pops and bubbles, can be minimized or, in some cases, eliminated. As a result, in certain embodiments of the present invention, the First and Second Basecoating Drying Steps are conducted at conditions that result in a substantially defect free basecoating applied on and/or within at least a portion of the cellulose-containing substrate. As used herein, the term “substantially defect free basecoating” means that visual flaws in the appearance of the basecoating composition and any subsequently applied topcoating composition, such as pops and bubbles, are at least minimized or, in some cases, eliminated altogether.

As indicated, in certain embodiments, the basecoating that is formed upon the surface of and/or within the cellulose-containing substrate is dried sufficiently to enable application of a topcoating composition such that the quality of the topcoating composition will not be affected adversely by further drying of the basecoating composition. For waterborne basecoats, this means the almost complete absence of water from the basecoat. As used herein, the term “dried sufficiently” when referring to a basecoating, means that the coating exhibits a pencil hardness of at least 2B (measured according to ASTM D3363-92A) and/or, when subjected to double rubs with a cloth soaked in methyl ethyl ketone will endure at least 10 double rubs without removing the coating.

In certain embodiments, following the Second Basecoating Drying Step, an additional drying and/or curing step may be employed, depending upon the presence of any liquid in the basecoat coating composition after the Second Basecoating Drying Step and the composition of the basecoat coating composition itself. For example, and without limitation, in embodiments wherein the basecoat coating composition includes a radiation curable material, such an ethylenically unsaturated material, an additional curing step may comprise exposing the composition to radiation, such as ultraviolet radiation, as understood by those skilled in the art, to effect crosslinking of crosslinkable components in the composition.

Once a basecoating is formed, certain embodiments of the present invention comprise a cooling step in which the temperature of the substrate having the dried basecoating thereon is cooled, such as to a temperature of 20° C. to 60° C., such as 25° C. to 30° C. The cooling step may, in certain cases, facilitate application of the topcoating composition to the substrate by preventing a rapid flash of volatiles in the topcoat composition that can cause poor flow, rough surfaces and generally poor appearance. The substrate can be cooled in air at a temperature of 15° C. to 35° C., such as 25° C. to 30° C. for a period of 15 to 45 minutes. Alternatively or additionally, the substrate can be cooled by exposure to chilled, saturated air blown onto the surface of the substrate at 4 to 10 meters per second to prevent cracking of the coating.

In certain embodiments, after the basecoating has been dried (and/or cooled, if desired), a clearcoat coating composition may be applied over the basecoat to form a multi-component composite topcoating. As previously indicated, the clearcoat coating composition can be liquid, powder or powder slurry, as desired. In certain embodiments, the clearcoating coating composition is a liquid composition that comprises a film-forming material, such as those previously described, and a volatile material.

In certain embodiments, a liquid clearcoat coating composition, after application to the cellulose-containing substrate, is then dried by exposing the clearcoat coating composition to low velocity air to volatilize at least a portion of the volatile material from the composition and set the composition. In certain embodiments, the drying process comprises exposing the clearcoat coating composition to air having a temperature of 10° C. to 50° C. for a period of at least 30 seconds, such as at least 1 minute, to volatilize at least a portion of any volatile material that may be present in the composition and set the composition (“hereinafter referred to as the “Clearcoating Flash Step”). In certain embodiments, the velocity of the air used in the Clearcoating Flash Step is less than 4 meters per second, such as from 0.5 to 4 meters per second and, in some cases, 0.7 to 1.5 meters per second.

The volatilization or evaporation of volatiles from the liquid clearcoat coating composition in the Clearcoating Flash Step can be carried out in the open air or in a Clearcoating Flash Step chamber (which may be the same or different than the Pretreatment Flash Step chamber described earlier) wherein air is circulated at low velocity to minimize airborne particle contamination. In certain embodiments, the cellulose-containing substrate is positioned at the entrance to the Clearcoating Flash Step chamber and slowly moved therethrough in assembly-line manner at a rate which permits the volatilization of volatile materials in the clearcoat coating composition, as discussed above. The rate at which the substrate is moved through the Clearcoating Flash Step chamber and the other drying chambers discussed below depends in part upon the length and configuration of the chamber, but, in some cases, is from 1 to 10 meters per minute for a continuous process. One skilled in the art would understand that individual dryers can be used for each step of the process or that a single dryer having a plurality of individual chambers or sections configured to correspond to each step of the process can be used, as desired.

In certain embodiments, the air is supplied to the Clearcoating Flash Step chamber by a blower or dryer, such as was described earlier with respect to the Flash Step associated with the wood pretreatment composition.

In certain embodiments of the present invention, the drying of the clearcoat coating composition comprises exposing the cellulose-containing substrate simultaneously to warm air and infrared radiation at conditions sufficient to form a pre-dried clearcoating on at least a portion of the cellulose-containing substrate (hereinafter referred to as the “First Clearcoating Drying Step”). As used herein, the term “pre-dried clearcoating” means that the liquid content of the composition is reduced by at least an amount sufficient to result in a substrate surface that is free of any visible puddles of liquid. In certain embodiments, this means that at least 25% of the liquid is removed from the clearcoat composition during the First Clearcoating Drying Step.

In certain embodiments, the First Clearcoating Drying Step comprises applying infrared radiation and low velocity warm air simultaneously to the clearcoating composition for a period of at least 1 minute, such as 1 to 3 minutes, such that the temperature of the cellulose-containing substrate is increased at a rate of 0.2° C. to 2° C. per second, such as 0.2° C. to 1.5° C. per second, to achieve a peak substrate temperature of 30° C. to 120° C., such as 35° C. to 110° C., so as to form a pre-dried clearcoating on the surface of and/or within the cellulose-containing substrate.

In certain embodiments, the infrared radiation applied in the First Clearcoating Drying Step includes near-infrared region (0.7 to 1.5 micrometers) and intermediate-infrared region (1.5 to 20 micrometers) radiation, such as from 0.7 to 4 micrometers. In certain embodiments, the infrared radiation is emitted in the First Clearcoating Drying Step at a power density of 1.0 to 2.5 kilowatts per square meter (kW/m²) of emitter wall surface.

In certain embodiments, the infrared radiation is emitted in the First Clearcoating Drying Step by a plurality of emitters arranged in the interior drying chamber of a combination infrared/convection drying apparatus of the type described earlier with respect to the drying of a wood pretreatment composition.

In certain embodiments, the combination infrared/convection drying apparatus includes baffled side walls having nozzles or slot openings through which air is passed to enter the interior drying chamber at a velocity of less than 4 meters per second. During the First Clearcoating Drying Step, the velocity of the air at the surface of the substrate is often less than 4 meters per second, such as from 0.5 to 2 meters per second or, in some cases, 0.7 to 1.5 meters per second. In certain embodiments, the temperature of the air used in the First Clearcoating Drying Step is 25° C. to 70° C., such as 30° C. to 60° C. The air may be supplied by a blower or dryer and can be preheated externally or by passing the air over the heated infrared emitter lamps and their reflectors, as described above with respect to the wood pretreatment composition.

In certain embodiments of the present invention, the drying of the clearcoating composition comprises exposing the cellulose-containing substrate simultaneously to warm air and infrared radiation at conditions sufficient to form a dried clearcoating on at least a portion of the surface of the cellulose-containing substrate (hereinafter referred to as the “Second Clearcoating Drying Step”). As used herein, the term “dried clearcoating,” means that upon completion of the Second Clearcoating Coating Drying Step at least 65%, or, in some cases, at least 80%, by weight of the liquid originally in the clearcoat coating composition has been removed therefrom. In certain embodiments, the term “dried clearcoating,” also means that the coating exhibits a pencil hardness of at least 2B (measured according to ASTM D3363-92A) and/or, when subjected to double rubs with a cloth soaked in methyl ethyl ketone, will endure at least 10 double rubs without removing the coating.

In certain embodiments, the Second Clearcoating Drying Step comprises applying infrared radiation and warm air simultaneously to the clearcoating composition for a period of at least 0.5 minutes, such as 0.5 to 3 minutes. In certain embodiments, the temperature of the cellulose-containing substrate is increased in the Second Clearcoating Drying Step at a rate of 0.1° C. to 1° C. per second, such as 0.5° C. to 0.7° C., per second, to achieve a peak substrate temperature of 60° C. to 140° C., such as 90° C. to 130° C.

The Second Clearcoating Drying Step can be carried out in a similar manner to that of the First Clearcoating Drying Step described above using a combination infrared radiation/convection drying apparatus, however the rate at which the temperature of the substrate is increased and peak substrate temperature vary as specified.

In certain embodiments, the infrared radiation applied in the Second Topcoating Drying Step includes near-infrared region (0.7 to 1.5 micrometers) and intermediate-infrared region (1.5 to 20 micrometers) radiation, and, in some cases, ranges from 0.7 to 4 micrometers. In certain embodiments, the infrared radiation is emitted in the Second Clearcoating Drying Step at a power density of 3 to 10 kilowatts per square meter (kW/m²) of emitter wall surface, such as 4 to 8 kW/m².

In certain embodiments, the warm drying air applied in the Second Clearcoating Drying Step has a temperature of 35° C. to 90° C., such as 50° C. to 80° C. The velocity of the air at the surface of the cellulose-containing substrate in the Second Clearcoating Drying Step is, in certain embodiments, less than 6 meters per second, and, in some cases, ranges from 1 to 4 meters per second.

The Second Clearcoating Drying Step can be carried out using any conventional combination infrared/convection drying apparatus such as the BGK combined infrared radiation and heated air convection oven which is described in detail above. The individual emitters can be configured as discussed above and controlled individually or in groups by a microprocessor provide the desired heating and infrared energy transmission rates.

By controlling the peak substrate temperature and the rate at which the substrate temperature is increased during the First and Second Clearcoating Drying Steps, flaws in the appearance of the clearcoating, such as pops and bubbles, can be minimized or, in some cases, eliminated. As a result, in certain embodiments of the present invention, the First and Second Clearcoating Drying Steps are conducted at conditions that result in a substantially defect free clearcoating applied on at least a portion of the surface of the cellulose-containing substrate. As used herein, the term “substantially defect free clearcoating” means that visual flaws in the appearance of the clearcoating composition, such as pops and bubbles, are at least minimized or, in some cases, eliminated altogether.

Once a clearcoating is formed, certain embodiments of the present invention comprise a cooling step in which the temperature of the substrate having the dried clearcoating thereon is cooled, such as to a temperature of 20° C. to 60° C., such as 25° C. to 30° C. The substrate can be cooled in air at a temperature of 15° C. to 35° C., such as 25° C. to 30° C., for a period of 15 to 45 minutes. Alternatively or additionally, the substrate can be cooled by exposure to chilled, saturated air blown onto the surface of the substrate at 4 to 10 meters per second to prevent cracking of the coating.

Therefore, as should be apparent from the foregoing description, certain embodiments of the present invention are directed to methods for making an at least partially treated and/or coated cellulose-containing substrate, comprising (a) applying a treatment composition or coating composition to at least a portion of the cellulose-containing substrate; and (b) drying the treatment composition or coating composition, wherein the drying step comprises (i) exposing the cellulose-containing substrate simultaneously to warm air and infrared radiation at conditions sufficient to form a pre-dried treatment composition or coating composition on and/or within at least a portion of the cellulose-containing substrate; and (ii) exposing the cellulose-containing substrate comprising the pre-dried treatment composition or coating composition simultaneously to warm air and infrared radiation at conditions sufficient to form a dried treatment or coating on and/or within at least a portion of the cellulose-containing substrate. In certain embodiments, the drying step is conducted at conditions that result in a substantially defect free treatment and/or coating.

As should also be apparent from the foregoing description, the present invention is also directed to methods for reducing the cycle time to for drying a treatment composition or coating composition deposited on and/or within at least a portion of the surface of a cellulose-containing substrate, comprising drying the treatment composition or coating composition by a method comprising (i) exposing the cellulose-containing substrate simultaneously to warm air and infrared radiation at conditions sufficient to form a pre-dried treatment composition or coating composition on and/or within at least a portion of the cellulose-containing substrate; and (ii) exposing the cellulose-containing substrate comprising the pre-dried treatment composition or coating composition simultaneously to warm air and infrared radiation at conditions sufficient to form a dried treatment or coating on and/or within at least a portion of the cellulose-containing substrate.

In addition, it should be apparent to the skilled artisan that the present invention is also directed to methods for making an at least partially coated cellulose-containing substrate comprising (a) applying a wood pretreatment composition to at least a portion of the cellulose-containing substrate, (b) drying the wood pretreatment composition, (c) applying an intermediate coating composition to the cellulose-containing substrate over at least a portion of the wood pretreatment composition, (d) drying the intermediate coating composition, (e) applying a topcoat coating composition to the cellulose-containing substrate over at least a portion of the intermediate coating composition, and (f) drying the topcoat coating composition, wherein (1) the wood pretreatment composition is dried by (i) exposing the cellulose-containing substrate simultaneously to warm air and infrared radiation at conditions sufficient to form a pre-dried treatment on and/or within at least a portion of the cellulose-containing substrate; and (ii) exposing the cellulose-containing substrate comprising the pre-dried treatment simultaneously to warm air and infrared radiation at conditions sufficient to form a dried treatment on and/or within at least a portion of the cellulose-containing substrate; (2) the intermediate coating composition is dried by (i) exposing the cellulose-containing substrate simultaneously to warm air and infrared radiation at conditions sufficient to form a pre-dried intermediate coating composition on and/or within at least a portion of the cellulose-containing substrate; and (ii) exposing the cellulose-containing substrate comprising the pre-dried intermediate coating composition simultaneously to warm air and infrared radiation at conditions sufficient to form a dried intermediate coating composition on and/or within at least a portion of the cellulose-containing substrate; and/or (3) the topcoat coating composition is dried by (i) exposing the cellulose-containing substrate simultaneously to warm air and infrared radiation at conditions sufficient to form a pre-dried topcoat coating composition on at least a portion of the cellulose-containing substrate; and (ii) exposing the cellulose-containing substrate comprising the pre-dried topcoat coating composition simultaneously to warm air and infrared radiation at conditions sufficient to form a dried topcoat coating composition on at least a portion of the cellulose-containing substrate.

As will also be appreciated by the skilled artisan, the present invention is also directed to cellulose-containing substrates at least partially treated and/or coated by such methods as well as apparatus that at least partially treat and/or coat a cellulose-containing substrate by such methods.

In yet other respects, the present invention is directed to methods for reducing the amount of cure catalyst and/or curing agent required in a single component or extended potlife multi-component coating composition to be dried within a selected amount of time after application to at least a portion of a cellulose-containing substrate. These methods comprise drying the coating composition by (i) exposing the cellulose-containing substrate simultaneously to warm air and infrared radiation at conditions sufficient to form a pre-dried coating composition on and/or within at least a portion of the cellulose-containing substrate; and (ii) exposing the cellulose-containing substrate comprising the pre-dried coating composition simultaneously to warm air and infrared radiation at conditions sufficient to form a dried coating on and/or within at least a portion of the cellulose-containing substrate. As indicated, such methods may allow formulation of single component coating compositions or extended potlife multi-component coating compositions containing reduced amounts of cure catalysts and/or crosslinking agents, while still provided short drying cycle times.

Illustrating the invention is the following example that is not to be considered as limiting the invention to its details. All parts and percentages in the examples, as well as throughout the specification, are by weight unless otherwise indicated.

### EXAMPLE

Uncoated wood substrates were coated with a waterborne radiation curable coating composition, A1380Z73, commercially available from PPG Industries, Inc, to evaluate the removal of volatiles when practicing certain methods of the present invention. The coatings were applied at film thicknesses and dried, using a combination of infrared radiation and heated air convection, as specified in Table 1. The calculated final weight solids for films on wood boards is also reported in Table 1.

TABLE 1

| | | | Zone 1 | Zone 2 | Zone 1 | Zone 2 | |
|---|---|---|---|---|---|---|---|
| | Ambient | Oven | Air | Air | % IR | % Power | Calculated |
| | Flash Time | Time | Temp. | Temp. | Lamp | to IR | Final Weight |
| Example | (min) | (min) | (° F.) | (° F.) | Power | Lamp | Solids |
| 1 | 30 | 45 | 100 | 200 | 10 | 100 | 95.89 |
| 2 | 2.5 | 90 | 100 | 200 | 10 | 45 | 95.91 |
| 3 | 4 | 180 | 100 | 200 | 5 | 30 | 81.85 |
| 4 | 4 | 90 | 140 | 140 | 5 | 60 | 77.97 |
| 5 | 30 | 180 | 140 | 140 | 15 | 45 | 79.51 |
| 6 | 4 | 45 | 120 | 120 | 10 | 100 | 91.67 |
| 7 | 30 | 90 | 120 | 120 | 15 | 30 | 81.95 |

Example 7 demonstrates a comparative example of a typical practice for removing volatiles from a waterborne coating prior to curing using an ambient flash followed by a heated stage or bake. As compared with example 7, example 5 demonstrates that no more volatiles were removed by increasing the bake temperature to 140° F. even when doubling the bake time. Example 3 demonstrates that staged bake to 200° F. did not remove more volatiles. As compared with Example 7, Example 4 demonstrates that no more volatiles were removed by extending the length of the ambient flash (and in this case the bake temperature was also increased). Examples 1, 2 and 6 demonstrate a greater removal of volatiles by using certain methods of the present invention. Example 6 demonstrates improved removal of volatiles with greater IR at the lowest bake temperature. Example 1 demonstrates a further improvement relative to Example 6 with a staged bake. Example 2 demonstrates improved volatility by coupling a staged bake and stage IR treatment with moderate IR intensity.

It will be readily appreciated by those skilled in the art that modifications may be made to the invention without departing from the concepts disclosed in the foregoing description. Such modifications are to be considered as included within the following claims unless the claims, by their language, expressly state otherwise. Accordingly, the embodiments described in detail herein are illustrative only and are not limiting to the scope of the invention which is to be given the full breadth of the appended claims and any and all equivalents thereof.

We claim:

1. A method for making an at least partially treated and/or coated cellulose-containing substrate, comprising:
(a) applying a treatment composition or coating composition to at least a portion of the cellulose-containing substrate; and
(b) drying the treatment composition or coating composition,
wherein the drying step comprises (i) exposing the cellulose-containing substrate simultaneously to warm air and infrared radiation at conditions sufficient to form a pre-dried treatment composition or coating composition on and/or within at least a portion of the cellulose-containing substrate; and (ii) exposing the cellulose-containing substrate comprising the pre-dried treatment composition or coating composition simultaneously to warm air and infrared radiation at conditions sufficient to form a dried treatment or coating on and/or within at least a portion of the cellulose-containing substrate.

2. A cellulose-containing substrate at least partially treated and/or coated by the method of claim 1.

3. An apparatus that at least partially treats and/or coats a cellulose-containing substrate by the method of claim 1.

4. The method of claim 1, wherein the cellulose-containing substrate comprises a wood/resin composite.

5. The method of claim 1, wherein the treatment composition comprises a wood preservative treatment composition.

6. The method of claim 5, wherein the wood preservative treatment composition comprises a diluent, a film-forming resin, a wood preservative, and a water repellent.

7. The method of claim 5, wherein the pre-dried treatment composition is formed by exposing the cellulose-containing substrate simultaneously to warm air and infrared radiation for at least 1 minute such that the temperature of the cellulose-containing substrate is increased at a rate of 0.2° C. to 2° C. per second to achieve a peak substrate temperature of 30° C. to 120° C.

8. The method of claim 7, wherein the velocity of the air at the surface of the substrate is less than 4 meters per second and the temperature of the air is 25° C. to 70° C.

9. The method of claim 5, wherein the dried treatment is formed by exposing the cellulose-containing substrate simultaneously to warm air and infrared radiation for at least 0.5 minutes such that the temperature of the cellulose-containing substrate is increased at a rate of 0.1° C. to 1° C. per second to achieve a peak substrate temperature of 40° C. to 100° C.

10. The method of claim 5, wherein the treatment composition is dried at conditions that result in a substantially defect free treatment composition applied on and/or within at least a portion of the cellulose-containing substrate.

11. The method of claim 1, wherein the coating composition is a colorizing coating composition, an intermediate coating composition and a topcoat coating composition.

12. The method of claim 11, wherein the topcoat coating composition comprises two or more coating compositions selected from a pigmented basecoat coating composition and a clearcoat coating composition.

13. The method of claim 11, wherein the coating composition comprises a thermosetting film-forming resin and a volatile material.

14. The method of claim 11, wherein the coating composition is formed by exposing the cellulose-containing substrate simultaneously to warm air and infrared radiation for at least 1 minute such that the temperature of the cellulose-containing substrate is increased at a rate of 0.2° C. to 2° C. per second to achieve a peak substrate temperature of 30° C. to 120° C.

15. The method of claim 13, wherein the velocity of the air at the surface of the substrate is less than 4 meters per second and the temperature of the air is 25° C. to 70° C.

16. The method of claim 11, wherein the dried coating is formed by exposing the cellulose-containing substrate simultaneously to warm air and infrared radiation for at least 0.5 minutes such that the temperature of the cellulose-containing substrate is increased at a rate of 0.1° C. to 1° C. per second to achieve a peak substrate temperature of 40° C. to 100° C.

17. The method of claim 11, wherein the composition is dried at conditions that result in a substantially defect free coating applied on and/or within at least a portion of the cellulose-containing substrate.

18. A method for reducing the cycle time for drying a treatment composition or coating composition deposited on and/or within at least a portion of a cellulose-containing substrate, comprising:
drying the treatment composition or coating composition by a method comprising (i) exposing the cellulose-containing substrate simultaneously to warm air and infrared radiation at conditions sufficient to form a pre-dried treatment composition or coating composition on and/or within at least a portion of the cellulose-containing substrate; and (ii) exposing the cellulose-containing substrate comprising the pre-dried treatment composition or coating composition simultaneously to warm air and infrared radiation at conditions sufficient to form a dried treatment or coating on and/or within at least a portion of the cellulose-containing substrate.

19. A method for making an at least partially coated cellulose-containing substrate comprising:
(a) applying a wood pretreatment composition to at least a portion of the cellulose-containing substrate,
(b) drying the wood pretreatment composition,
(c) applying an intermediate coating composition to the cellulose-containing substrate over at least a portion of the wood pretreatment composition,
(d) drying the intermediate coating composition,
(e) applying a topcoat coating composition to the cellulose-containing substrate over at least a portion of the intermediate coating composition, and
(f) drying the topcoat coating composition, wherein
(1) the wood pretreatment composition is dried by (i) exposing the cellulose-containing substrate simultaneously to warm air and infrared radiation at conditions sufficient to form a pre-dried treatment on and/or within at least a portion of the cellulose-containing substrate; and (ii) exposing the cellulose-containing substrate comprising the pre-dried treatment simultaneously to warm air and infrared radiation at conditions sufficient to form a dried treatment on and/or within at least a portion of the cellulose-containing substrate;
(2) the intermediate coating composition is dried by (i) exposing the cellulose-containing substrate simultaneously to warm air and infrared radiation at conditions sufficient to form a pre-dried intermediate coating composition on and/or within at least a portion of the cellulose-containing substrate; and (ii) exposing the cellulose-containing substrate comprising the pre-dried intermediate coating composition simultaneously to warm air and infrared radiation at conditions sufficient to form a dried intermediate coating composition on and/or within at least a portion of the cellulose-containing substrate; and/or
(3) the topcoat coating composition is dried by (i) exposing the cellulose-containing substrate simultaneously to warm air and infrared radiation at conditions sufficient to form a pre-dried topcoat coating composition on at least a portion of the cellulose-containing substrate; and (ii) exposing the cellulose-containing substrate comprising the pre-dried topcoat coating composition simultaneously to warm air and infrared radiation at conditions sufficient to form a dried topcoat coating composition on at least a portion of the cellulose-containing substrate.

20. A method for reducing the amount of cure catalyst and/or curing agent required in a single component or extended potlife multi-component coating composition to be dried within a selected amount of time after application to at least a portion of a cellulose-containing substrate, the method comprising:
drying the coating composition by (i) exposing the cellulose-containing substrate simultaneously to warm air and infrared radiation at conditions sufficient to form a pre-dried coating composition on and/or within at least a portion of the cellulose-containing substrate; and (ii) exposing the cellulose-containing substrate comprising the pre-dried coating composition simultaneously to warm air and infrared radiation at conditions sufficient to form a dried coating on and/or within at least a portion of the cellulose-containing substrate.
